(19) United States
(12) Patent Application Publication
(10) Pub. No.: US 2025/0250431 A1
(43) Pub. Date: Aug. 7, 2025

(54) ENVIRONMENT-FRIENDLY WATERBORNE POLYURETHANE DISPERSION (PUD) MODIFIED ACRYLIC WATERPROOF COATING AND PREPARATION METHOD

(71) Applicant: SIKA TECHNOLOGY AG, Baar (CH)

(72) Inventors: Weiwei JI, Suzhou (CN); Qi WANG, Suzhou (CN)

(73) Assignee: SIKA TECHNOLOGY AG, Baar (CH)

(21) Appl. No.: 18/855,059

(22) PCT Filed: Apr. 13, 2022
(86) PCT No.: PCT/CN2022/086643

§ 371 Date: Oct. 8, 2024

(51) Int. Cl. C08K 3/26; C08K 3/22; C08K 3/30; C08L 33/04; C09D 5/02; C09D 7/61; C09D 133/04

(52) U.S. Cl. CPC C08L 33/04; C08K 3/26; C09D 5/027; C09D 7/61; C09D 133/04; C08K 2003/2296; C08K 2003/265; C08K 2003/3045; C08L 2201/52; C08L 2205/03

(57) ABSTRACT

A polyurethane-acrylic composition, and particularly, a polyurethane-acrylic composition that is environment friendly and exhibits low heat shrinkage, which is suitable for use as a waterproof coating for a construction structure, especially for a roof. The polyurethane-acrylic composition includes:—at least one aqueous acrylic polymer dispersion, preferably in an amount of 17-56 wt %, preferably 20-45 wt %, based on the total weight of the composition; and—at least one aqueous polyurethane dispersion, preferably in an amount of 4-30 wt %, preferably 4-10 wt %, based on the total weight of the composition; wherein the composition is free of a coalescing agent.

### TECHNICAL FIELD

The present invention generally relates to a polyurethane-acrylic composition, and particularly, to a polyurethane-acrylic composition that is environment friendly and exhibits low heat shrinkage, which is suitable for use as a waterproof coating for a construction structure, especially for a roof.

### STATE OF THE ART

Aqueous acrylic and polyurethane dispersions have been widely used in coating applications, especially in waterproof coating application.

One-component polyurethane waterproof coating has excellent elasticity and tensile strength, good water resistance and flexibility at −35° C. It has been widely used in China, but poor weather resistance has restricted it use in exposed projects. Most of the traditional one-component polyurethane waterproof coatings are cured into a film by the reaction of prepolymer containing-NCO with moisture in the air, so the construction process is susceptible to environmental humidity. If one-time construction is too thick, defects such as air bubbles and pinholes will occur. In addition, the system contains a lot of organic volatiles, which brings great harm to the health of construction workers and also causes serious environmental pollution.

One-component acrylic waterproof coating has excellent weather resistance, but it is difficult to obtain mechanical properties and low-temperature flexibility at the same time. China has a vast territory, with large differences in climate between northern and southern provinces, temperature in the north can be as low as −20° C. to −30° C. in winter. In order to obtain an acrylic waterproof coating with good flexibility at low temperature, high elasticity and tensile strength at the same time, acrylic emulsion with a higher glass transition temperature (Tg) combined with a coalescing agent is a more common solution on the market at present.

However, the coalescing agent has a higher boiling point, and will migrate to the surface of the coating film and volatilize into the air as the service time increases. With the volatilization of the coalescing agent, the flexibility of the coating film at low temperature decreases sharply, and the volume of the coating shrinks. In severe cold areas in winter, coating film will become brittle and crack, and the adhesion also decreases. It severely reduces the durability of the film, and also causes great pollution to the environment.

CN 108178958 A relates to a metal roof waterproof coating and a preparation method. The invention addresses the problem of low-temperature flexibility, weather resistance and UV stability. These products however have poor mechanical properties and acid resistance.

CN108178958A discloses an aqueous acrylic waterproof coating material and a preparation method thereof. The aqueous acrylic waterproof coating material claims the advantages that the drying of the coated film is rapid in the case of thick coating constructions, the waterproof coated film can achieve the low water content in the same time, hence the waiting time before the next construction can be shortened, the construction period can be shortened, and the construction speed of the project can be improved.

CN113527966A relates to the technical field of waterproof coatings, in particular to a water-based polyurea composite modified single-component acrylic acid waterproof coating and a preparation method thereof. The invention addresses the problem of high water absorption of the waterproof coating.

Again, despite of a variety of existing waterproof coatings, none of these can achieve low VOC and good performance properties, such as, low heat shrinkage, good low temperature flexibility, good acid resistance, good mechanical properties at the same time. There is a need for a new waterproofing coating than can solve the shortcomings of existing waterproof coatings in performance and environmental protection.

### SUMMARY OF THE INVENTION

Therefore, an object of the present invention is to provide a new waterproof composition, which is suitable for use as a waterproof coating, having low VOC and good performance properties, such as, low heat shrinkage, good low temperature flexibility, good acid resistance, good mechanical properties (such as high tensile strength, good elasticity and large elongation at break), and also exhibits excellent weather resistance, long waterproof life, wide practical range, easy construction and maintenance.

Surprisingly, this object has been solved by a polyurethane-acrylic composition as defined in claim 1, which comprises at least one aqueous acrylic polymer dispersion and at least one aqueous polyurethane dispersion and is free of a coalescing agent. Specifically, by eliminating the coalescing agent, low VOC and thus environment protection can be achieved, at the same time, an improvement on the performance stability of the coating film during the service period can be achieved. In addition, by introducing the aqueous polyurethane dispersion, into the aqueous acrylic polymer dispersion, excellent performance, such as high strength, high elongation at break, and low temperature flexibility at the same time of the coating film can be achieved.

Further aspects of the invention are the subject of further independent claims. Particularly preferred embodiments of the invention are the subject of the dependent claims.

### BRIEF DESCRIPTION OF THE DRAWINGS

FIG. 1 shows the storage stability test result of example 1.

FIG. 2 shows the storage stability test result of example 2.

FIG. 3 shows the storage stability test result of example 3.

FIG. 4 shows the freeze thaw resistance test result of example 8.

FIG. 5 shows the freeze thaw resistance test result of example 9.

FIG. 6 shows the freeze thaw resistance test result of example 10.

FIG. 7 shows the Q-UV A test results of example 10.

FIG. 8 shows the Q-UV A test results of example 13.

FIG. 9 shows the freeze thaw resistance test result of example 21.

### WAYS OF EXECUTING THE INVENTION

In a first aspect, the present invention provides a polyurethane-acrylic composition, preferably a polyurethane-acrylic coating composition, preferably a polyurethane-acrylic waterproof coating composition, characterized in that, it comprises:
at least one aqueous acrylic polymer dispersion, preferably in an amount of 17-56 wt %, preferably 20-45 wt %, based on the total weight of the composition; and
at least one aqueous polyurethane dispersion, preferably in an amount of 4-30 wt %, preferably 4-10 wt %, based on the total weight of the composition;
   wherein the composition is free of a coalescing agent.

In a second aspect, the present invention provides waterproofing a construction structure, especially a roof, with the polyurethane-acrylic composition as described above, characterized in that, it comprises the following steps:
a) stirring the composition by means of mechanical stirring until achieving complete homogeneity thereof;
b) applying the composition resulting from the previous step a) on the roof by means of a roller, brush, trowel or by spraying.

In a third aspect, the present invention provides a use of the polyurethane-acrylic composition as described above as waterproofing coating for a construction structure, especially for a roof.

In a fourth aspect, the present invention provides a construction structure, especially a roof, coated with the polyurethane-acrylic composition as described.

### Definitions

Substance names beginning with “poly”, such as polyamine, polyol or polycyanate, refer to substances containing, in a formal sense, two or more of the functional groups that occur in their name per molecule.

An “aromatic isocyanate” refers to an isocyanate wherein the isocyanate groups are bonded directly to an aromatic carbon atom. Accordingly, isocyanate groups of this kind are referred to as “aromatic isocyanate groups”.

An “aliphatic isocyanate” refers to an isocyanate wherein the isocyanate groups are bonded directly to an aliphatic carbon atom. Accordingly, isocyanate groups of this kind are referred to as “aliphatic isocyanate groups”.

The term “(meth)acrylic” designates methacrylic or acrylic. Accordingly, the term “(meth)acrylate” designates methacrylate or acrylate.

The term “polyacrylate polymer” designates polymers resulting from the polymerization of two or more (meth)acrylate monomers. Copolymers of the (meth)acrylate monomers and copolymers of (meth)acrylate monomers with other vinyl group containing monomers, such as styrene, are also included within the term “polyacrylate polymer”. The terms “polyacrylate polymer”, “polyacrylate” and “acrylate polymer” are used interchangeably.

“Molecular weight” of polymers is understood as the average molecular weight of their chain length distribution. “Average molecular weight” refers to the number-average molecular weight (Mn) of a polydisperse mixture of oligomeric or polymeric molecules or molecule residues. It is determined by means of gel permeation chromatography (GPC) against polystyrene as standard, especially with tetrahydrofuran as mobile phase, refractive index detector and evaluation from 200 g/mol.

The term “glass transition temperature (Tg)” refers to the temperature measured by differential scanning calorimetry (DSC) according to ISO 11357 standard above which temperature a polymer component becomes soft and pliable, and below which it becomes hard and glassy. The measurements can be performed with a Mettler Toledo 822e device at a heating rate of 2° C./min. The Tg values can be determined from the measured DSC curve with the help of the DSC software.

The “solids content” refers in the present document to the portion of the composition, which when heated to a temperature of 105° C. for one hour at one atmosphere pressure does not volatilize. Accordingly, the solids content refers to polymeric materials, non-volatile plasticizers, inorganic solids and non-volatile organic materials, whereas the non-solid portion is generally comprised of water and any organic materials readily volatilized at 105° C.

The term “viscosity” refers to the dynamic viscosity or shear viscosity which is determined by the ratio between the shear stress and the shear rate (speed gradient) and is determined as described in DIN EN ISO 3219.

The term “particle size” refers to the area-equivalent spherical diameter of a particle. The particle size distribution can be measured by laser diffraction according to the method as described in standard ISO 13320:2009. A Mastersizer 2000 device (trademark of Malvern Instruments Ltd, GB) can be used in measuring particle size distribution.

The unit term “wt %” means percentage by weight, based on the weight of the respective total composition, if not otherwise specified. The terms “weight” and “mass” are used interchangeably throughout this document. All industrial norms and standard methods mentioned in this document are referring to the respective current versions at the time of filing.

“Room temperature” refers to a temperature of 23° C.

The term “dispersion” refers to a physical state of matter that includes at least two distinct phases, wherein a first phase is distributed in a second phase, with the second phase being a continuous medium. Preferably, the dispersion comprises a solid phase which is dispersed as solid particles in a continuous liquid phase.

The term “waterborne polymer dispersion”, “aqueous polymer dispersion” or “water-based polymer dispersion” refers to a polymer dispersion having water as the main carrier. Preferably, the “waterborne”, “aqueous” or “water-based” refers to a 100% water carrier.

The term “volatile organic compounds” (VOC) herein means organic compounds that have a boiling point of less than 250° C. at a standard pressure of 101.3 kPa. The standard boiling point can be determined, for example, with an ebulliometer.

### Aqueous Polyurethane Dispersion

The polyurethane emulsion is a polyurethane dispersion that contains an emulsifier in an aqueous dispersion. It can be made by external emulsification method. The polyurethane emulsion preferably has a particle size of >0.1 μm, and its appearance is preferably white and cloudy. Since the polyurethane is not easily soluble in water, to disperse the polyurethane into water, strong stirring (higher shear force) and the action of a large amount of emulsifier are required. Most of the products of external emulsified polyurethane emulsion have coarser particle size and the residual of hydrophilic small molecule emulsifier, which will affect the performance of polyurethane film after curing, and now it has been gradually developed in the direction of self-emulsified polyurethane dispersion.

Usually, a polyurethane dispersion in water without emulsifiers are called aqueous polyurethane dispersion, or a polyurethane dispersion liquid, with a particle size of 0.001-0.1 μm and translucent appearance. It can be made by an internal emulsification method or a self-emulsification method. The substance with a salt-forming hydrophilic group reacts with the —NCO group of the prepolymer to produce hydrophilic polyurethane salt, which can be directly dispersed in water by stirring to obtain a translucent dispersion without adding emulsifier. According to the different hydrophilic groups introduced in the polyurethane molecule, it can be divided into anionic, cationic and nonionic types. In the film-forming process, water is gradually excluded, and its molecular chains and ionic groups are arranged in a regular pattern, and not only electrostatic effects and hydrogen bonding forces exist, but also cross-linking reactions occur between molecules to form a network structure. Since there is no emulsifier, these particles are not sensitive to mechanical stirring, heating or dilution, and are resistant to electrolytes; the resulting film is firm and elastic, with strong adhesion.

In a preferred embodiment of the present invention, the aqueous polyurethane dispersion is selected from a self-emulsified aqueous polyurethane dispersion, a aqueous polyurethane emulsion that containing an emulsifier, and a combination thereof, preferably a self-emulsified aqueous polyurethane dispersion.

A suitable polyurethane prepolymer containing isocyanate (—NCO) groups used on the polyurethane dispersion is especially obtained from the reaction of at least one polyol with a super stoichiometric amount of at least one isocyanate. The reaction is preferably conducted with exclusion of moisture at a temperature in the range from 50 to 160° C., optionally in the presence of suitable catalysts. The NCO/OH ratio is preferably in the range from 1.3/1 to 5/1, preferably 1.5/1 to 4/1, especially 1.8/1 to 3/1. The isocyanate remaining in the reaction mixture after the conversion of the OH groups, especially monomeric diisocyanate, can be removed, especially by means of distillation, which is preferable in the case of a high NCO/OH ratio. The polyurethane prepolymer obtained preferably has a content of free isocyanate groups in the range from 1% to 10% by weight, especially 1.5% to 6% by weight.

A suitable polycyanate is especially a commercially available polycyanate, especially
aromatic di- or triisocyanates, preferably diphenylmethane 4,4′- or 2,4′- or 2,2′-diisocyanate or any mixtures of these isomers (MDI), tolylene 2,4- or 2,6-diisocyanate or any mixtures of these isomers (TDI), mixtures of MDI and MDI homologs (polymeric MDI or PMDI), phenylene 1,3- or 1,4-diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), dianisidine diisocyanate (DADI), tris(4-isocyanatophenyl) methane or tris(4-isocyanatophenyl)thiophosphate; Preferably MDI or TDI;
aliphatic, cycloaliphatic or arylaliphatic di- or triisocyanates, preferably tetramethylene 1,4-diisocyanate, 2-methylpentamethylene 1,5-diisocyanate, hexamethylene 1,6-diisocyanate (HDI), 2,2,4- and/or 2,4,4-trimethylhexamethylene 1,6-diisocyanate (TMDI), decamethylene 1,10-diisocyanate, dodecamethylene 1,12-diisocyanate, lysine diisocyanate or lysine ester diisocyanate, cyclohexane 1,3- or 1,4-diisocyanate, 1-methyl-2,4- and/or -2,6-diisocyanatocyclohexane (H6TDI), 1-isocyanato-3,3,5-trimethyl-5-isocyanatomethylcyclohexane (IPDI), perhydrodiphenylmethane 2,4′- and/or 4,4′-diisocyanate (H12MDI), 1,3- or 1,4-bis(isocyanatomethyl)cyclohexane, m- or p-xylylene diisocyanate, tetramethylxylylene 1,3- or 1,4-diisocyanate, 1,3,5-tris(isocyanatomethyl)benzene, bis(1-isocyanato-1-methylethyl) naphthalene, dimer or trimer fatty acid isocyanates, such as, especially, 3,6-bis(9-isocyanatononyl)-4,5-di(1-heptenyl)cyclohexene (dimeryl diisocyanate); preferably H12MDI or HDI or IPDI;
oligomers or derivatives of the di- or triisocyanates mentioned, especially derived from HDI, IPDI, MDI or TDI, especially oligomers containing uretdione or isocyanurate or iminooxadiazinedione groups or various groups among these; or di- or polyfunctional derivatives containing ester or urea or urethane or biuret or allophanate or carbodiimide or uretonimine or oxadiazinetrione groups or various groups among these. In practice, polycyanates of this kind are typically mixtures of substances having different degrees of oligomerization and/or chemical structures. They especially have an average NCO functionality of 2.1 to 4.0.

Preferred polycyanates are aliphatic, cycloaliphatic or aromatic diisocyanates, especially HDI, TMDI, cyclohexane 1,3- or 1,4-diisocyanate, IPDI, H12MDI, 1,3- or 1,4-bis(isocyanatomethyl)cyclohexane, XDI, TDI, MDI, phenylene 1,3- or 1,4-diisocyanate or naphthalene 1,5-diisocyanate (NDI).

A particularly preferred polycyanate is HDI, IPDI, H12MDI, TDI, MDI or a form of MDI which is liquid at room temperature, especially HDI, IPDI, TDI or MDI.

A form of MDI which is liquid at room temperature is either 4,4′-MDI liquefied by partial chemical modification-especially carbodiimidization or uretonimine formation or adduct formation with polyols- or it is a mixture of 4,4′-MDI with other MDI isomers (2,4′-MDI and/or 2,2′-MDI), and/or with MDI oligomers and/or MDI homologs (PMDI), that has been brought about selectively by blending or results from the production process.

Most preferred is IPDI, TDI or MDI.

Suitable polyols are commercial polyols or mixtures thereof, especially
Polyether polyols, especially polyoxyalkylenediols and/or polyoxyalkylenetriols, especially polymerization products of ethylene oxide or 1,2-propylene oxide or 1,2- or 2,3-butylene oxide or oxetane or tetrahydrofuran or mixtures thereof, where these may be polymerized with the aid of a starter molecule having two or more active hydrogen atoms, especially a starter molecule such as water, ammonia or a compound having multiple OH or NH groups, such as, for example, ethane-1,2-diol, propane-1,2- or -1,3-diol, neopentyl glycol, diethylene glycol, triethylene glycol, the isomeric dipropylene glycols or tripropylene glycols, the isomeric butanediols, pentanediols, hexanediols, heptanediols, octanediols, nonanediols, decanediols, undecanediols, cyclohexane-1,3- or -1,4-dimethanol, bisphenol A, hydrogenated bisphenol A, 1,1,1-trimethylolethane, 1,1,1-trimethylolpropane, glycerol or aniline, or mixtures of the abovementioned compounds. Likewise suitable are polyether polyols with polymer particles dispersed therein, especially those with styrene/acrylonitrile (SAN) particles or polyurea or polyhydrazodicarbonamide (PHD) particles. Preferred polyether polyols are polyoxypropylene diols or polyoxypropylene triols, or what are called ethylene oxide-terminated (EO-endcapped) polyoxypropylene diols or triols. The latter are mixed polyoxyethylene/polyoxypropylene polyols which are especially obtained in that polyoxypropylene diols or triols, on conclusion of the polypropoxylation reaction, are further alkoxylated with ethylene oxide and thereby eventually have primary hydroxyl groups. Preferred polyether polyols have a degree of unsaturation of less than 0.02 meq/g, especially less than 0.01 meq/g.
Polyester polyols, also called oligoesterols, prepared by known processes, especially the polycondensation of hydroxycarboxylic acids or lactones or the polycondensation of aliphatic and/or aromatic polycarboxylic acids with di- or polyhydric alcohols. Preference is given to polyester diols from the reaction of dihydric alcohols, such as, especially, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the abovementioned alcohols, with organic dicarboxylic acids or the anhydrides or esters thereof, such as, especially, succinic acid, glutaric acid, adipic acid, suberic acid, sebacic acid, dodecanedicarboxylic acid, maleic acid, fumaric acid, phthalic acid, isophthalic acid, terephthalic acid or hexahydrophthalic acid or mixtures of the abovementioned acids, or polyester polyols from lactones, such as, especially, ε-caprolactone. Particular preference is given to polyester polyols from adipic acid or sebacic acid or dodecanedicarboxylic acid and hexanediol or neopentyl glycol.
Polycarbonate polyols as obtainable by reaction, for example, of the abovementioned alcohols—used to form the polyester polyols—with dialkyl carbonates, diaryl carbonates or phosgene.
Block copolymers bearing at least two hydroxyl groups and having at least two different blocks having polyether, polyester and/or polycarbonate structure of the type described above, especially polyether polyester polyols.
Polyacrylate polyols and polymethacrylate polyols.
Polyhydroxy-functional fats and oils, for example natural fats and oils, especially castor oil; or polyols obtained by chemical modification of natural fats and oils—called oleochemical polyols—for example the epoxy polyesters or epoxy polyethers obtained by epoxidation of unsaturated oils and subsequent ring opening with carboxylic acids or alcohols, or polyols obtained by hydroformylation and hydrogenation of unsaturated oils; or polyols obtained from natural fats and oils by degradation processes, such as alcoholysis or ozonolysis, and subsequent chemical linkage, for example by transesterification or dimerization, of the degradation products or derivatives thereof thus obtained. Suitable degradation products of natural fats and oils are especially fatty acids and fatty alcohols and also fatty acid esters, especially the methyl esters (FAME), which can be derivatized to hydroxy fatty acid esters by hydroformylation and hydrogenation, for example.
Polyhydrocarbon polyols, also called oligohydrocarbonols, such as, for example, polyhydroxy-functional polyolefins, polybutylenes, polyprenes; polyhydroxy-functional ethylene/propylene, ethylene/butylene or ethylene/propylene/diene copolymers, as produced, for example, by Kraton Polymers; polyhydroxy-functional polymers of dienes, especially of 1,3-butadiene, which can especially also be prepared from anionic polymerization; polyhydroxy-functional copolymers of dienes, such as 1,3-butadiene, or diene mixtures and vinyl monomers, such as styrene, acrylonitrile, vinyl chloride, vinyl acetate, vinyl alcohol, isobutylene and isoprene, for example polyhydroxy-functional acrylonitrile/butadiene copolymers, as can be prepared, for example, from epoxides or aminoalcohols and carboxyl-terminated acrylonitrile/butadiene copolymers (commercially available, for example, under the Hypro® CTBN or CTBNX or ETBN name from Emerald Performance Materials); and hydrogenated polyhydroxy-functional polymers or copolymers of dienes.

Also especially suitable are mixtures of polyols.

Preference is given to polyether polyols, polyester polyols, polycarbonate polyols, poly(meth)acrylate polyols or polybutadiene polyols.

Particular preference is given to polyether polyols, polyester polyols, especially aliphatic polyester polyols, or polycarbonate polyols, especially aliphatic polycarbonate polyols.

The most preferred are polyether polyols, especially polyoxypropylene di- or triols or ethylene oxide-terminated polyoxypropylene di- or triols.

Preference is given to polyols having an average molecular weight in the range from 400 to 20 000 g/mol, preferably from 1000 to 10 000 g/mol.

Preference is given to polyols having an average OH functionality in the range from 1.6 to 3.

Preference is given to polyols that are liquid at room temperature.

Preference is given to polyols which are solid at room temperature for the preparation of a polyurethane prepolymer which is solid at room temperature.

In the preparation of a polyurethane prepolymer containing isocyanate groups, it is also possible to use fractions of di- or polyfunctional alcohols, especially 1,2-ethanediol, 1,2-propanediol, 1,3-propanediol, 2-methyl-1,3-propanediol, 1,2-butanediol, 1,3-butanediol, 1,4-butanediol, 1,3-pentanediol, 1,5-pentanediol, 3-methyl-1,5-pentanediol, neopentyl glycol, dibromoneopentyl glycol, 1,2-hexanediol, 1,6-hexanediol, 1,7-heptanediol, 1,2-octanediol, 1,8-octanediol, 2-ethyl-1,3-hexanediol, diethylene glycol, triethylene glycol, dipropylene glycol, tripropylene glycol, 1,3- or 1,4-cyclohexanedimethanol, ethoxylated bisphenol A, propoxylated bisphenol A, cyclohexanediol, hydrogenated bisphenol A, dimer fatty acid alcohols, 1,1,1-trimethylolethane, 1,1,1-trimethylolpropane, glycerol, pentaerythritol, sugar alcohols, such as especially xylitol, sorbitol or mannitol, or sugars, such as especially sucrose, or alkoxylated derivatives of the alcohols mentioned or mixtures of the alcohols mentioned.

Preference is given to the additional use of butane-1,4-diol for applications in which particularly high strengths are desired.

The polyurethane polymer containing isocyanate groups preferably has an average molecular weight in the range from 1′000 to 20′000 g/mol, especially 1′500 to 10′000 g/mol. It is preferably liquid at room temperature.

In a preferred embodiment of the present invention, the at least one aqueous polyurethane has an amount of 2-35 wt %, preferably 4-30 wt %, preferably 4-20 wt %, preferably 4-10 wt %, preferably 4.5-8 wt %, based on the total weight of the composition.

In a preferred embodiment of the present invention, the aqueous polyurethane dispersion has a Tg of ≤−30° C., preferably ≤−35° C., preferably −30 to −40° C., preferably −35 to −40° C.

In the present invention, it is required that each of the at least one aqueous polyurethane dispersion has a Tg as defined above.

In a preferred embodiment of the present invention, the aqueous polyurethane dispersion has a solids content of 50-65%, preferably 57%-61%, a Efflux time of ≤90 s at 23° C., 4 mm cup.

Suitable commercially available aqueous polyurethane dispersions include Bayhydrol UH 2864 (from Covestro), Archsol® 8355 (from WANHUA), ALBERDINGK® U 400 N (from Alberdingk Boley).

By introducing the water-based polyurethane dispersion, especially the water-based polyurethane dispersion, into the aqueous acrylic polymer dispersion, several advantages can be achieved. First of all, PUD has excellent mechanical properties and flexibility at −35° C. During the film formation process, water gradually evaporates, and molecular chains and ionic groups are arranged regularly. Not only is there an electrostatic effect, but also cross-linking reaction occur between the molecules to form a network structure. Second, PUD has a Tg and minimum film forming temperature (MFFT). The introduction of PUD into acrylic system can promote curing of aqueous acrylic polymer dispersion to form a film without coalescing agent. It will be reflected in the excellent performance of acrylic and polyurethane.

The present inventors have found that the introduction of PUD is conducive to the film tensile strength, flexibility at low-temperature and reduces the water absorption of the coating. To some extent, PUD weakens the elongation at break of the coating. Besides, when the proportion of PUD is too high, for example, reaches 30%, the product performance has not been significantly improved, but it has brought huge cost pressure. Thus, considering both performance and cost effectiveness, PUD should be added in an appropriate amount.

### Aqueous Acrylic Polymer Dispersion

The aqueous acrylic polymer dispersion comprises at least one acrylic polymer. The term “acrylic polymer” refers in the present document to homopolymers, copolymers and higher inter-polymers of an acrylic monomer with one or more further acrylic monomers and/or with one or more other ethylenically unsaturated monomers. The term “acrylic monomer” refers in the present document to esters of (meth)acrylic acid, (meth)acrylic acid or derivatives thereof, for example, amides of (meth)acrylic acid or nitriles of (meth)acrylic acid. Preferably, the acrylic polymer contains at least 30% by weight, more preferably at least 40% by weight of acrylic monomers.

Particularly suitable acrylic polymers consist for the most part of (meth)acrylates of alcohols containing from 1 to 24 carbon atoms ((meth)acrylic acid ester monomers). There are preferably more than 25% by weight of these basic monomer building blocks in the acrylic polymer. Further monomer building blocks include, for example, vinyl esters and allyl esters of carboxylic acids containing from 1 to 20 carbon atoms, vinyl ethers of alcohols containing from 1 to 8 carbon atoms, vinyl aromatic compounds, in particular styrene, vinyl halides, non-aromatic hydrocarbons containing from 2 to 8 carbon atoms and at least one olefinic double bond, α and β-unsaturated mono- or di-carboxylic acids containing from 3 to 6 carbon atoms, and derivatives thereof (especially amides, esters and salts). Monomers containing silane-groups can also be present in the acrylic polymers.

Preferably, the acrylic polymer has a number average molecular weight (Mn) in the range of 5,000-200,000 g/mol, preferably 25,000-200,000 g/mol, most preferably 50,000-200,000 g/mol and/or a weight average molecular weight (Mw) in the range of 50,000-800,000 g/mol, preferably 100,000-800,000 g/mol, most preferably 150,000-800,000 g/mol.

Suitable aqueous acrylic polymer dispersion and preparation method thereof are described, for example in EP 0490191 A2, DE 19801892 A1, and in EP 0620243.

Suitable commercially available aqueous acrylic polymer dispersions include Primal® (from Dow Chemical), Arconal® (from BASF), Airflex® (from APP), Mowilith® (from Celanese), Rhoplex® (from Dow Chemical), Plextol® (from Synthomer), and Vinnapas® (from Wacker).

The aqueous acrylic polymer dispersion can comprise two or more different acrylic polymers having different glass transition temperatures and different monomer compositions. The aqueous acrylic polymer dispersion comprising two or more different acrylic polymers can be prepared by mixing commercially available acrylic polymer dispersions, such as those described above.

In a preferred embodiment of the present invention, the at least one aqueous acrylic polymer dispersion is selected from a pure acrylic emulsion, a styrene-acrylic emulsion, and a combination thereof, preferably a pure acrylic emulsion.

The pure acrylic emulsion comprises a variety of acrylic acids, methacrylic acids, methyl methacrylate and functional additives, which is an emulsion made by copolymerization by means of an optimized process. It has following performance characteristics: fine particle size, high gloss, good weather resistance, good after-tack resistance, and thus has a wide applicability. Since the pure acrylic emulsion has excellent weather resistance, especially has excellent resistance to aging, color and gloss retention, and tack resistance, it is a top-grade waterborne coating at present.

The styrene-acrylic emulsion is produced by copolymerization of styrene and acrylate. It has following performance characteristics: good adhesion, forming a transparent film, good resistance to water, oil, heat, aging, and alkali.

In a preferred embodiment of the present invention, the at least one aqueous acrylic polymer dispersion has an amount of 17-56 wt %, preferably 17-45 wt %, preferably 17-44 wt %, preferably 20-45 wt %, preferably 20-44 wt %, preferably 30-56 wt %, preferably 30-50 wt %, preferably 40-47 wt %, preferably 40-45 wt %, based on the total weight of the composition.

In a preferred embodiment of the present invention, the aqueous acrylic polymer dispersion has a Tg of ≤−10° C., preferably ≤−20° C., preferably −20 to −40° C., preferably −20 to −35° C., preferably −20 to −30° C. In the present invention, it is required that each of the at least one aqueous acrylic polymer dispersion has a Tg as defined above.

In a preferred embodiment of the present invention, the aqueous acrylic polymer dispersion has a solids content of 45-60%, preferably 52.5%-53.5%, and a viscosity of <1000 at 25° C.

In a preferred embodiment of the present invention, the at least one aqueous acrylic polymer dispersion comprises a first aqueous acrylic polymer dispersion and a second aqueous acrylic polymer dispersion having a Tg lower than that of the first aqueous acrylic polymer dispersion; preferably the first aqueous acrylic polymer dispersion has a Tg of ≤−10° C., preferably −20 to −30° C. and the second aqueous acrylic polymer dispersion has a Tg of ≤−30° C., preferably −30 to −40° C.

Preferably, the first aqueous acrylic polymer dispersion has an amount of 15-35 wt %, preferably 20-33 wt %, preferably 20-25 wt %, preferably 22-24 wt %, and the second aqueous acrylic polymer dispersion has an amount of 5-30 wt %, preferably 10-23 wt %, preferably 15-22 wt %, preferably 18-21 wt %, based on the total weight of the composition. Preferably, the first aqueous acrylic polymer dispersion is Primal® EC4811 (from Dow Chemical) and the second aqueous acrylic polymer dispersion is Primal® EC1791 (from Dow Chemical).

With addition of the second aqueous acrylic polymer dispersion with a lower Tg, the flexibility of the film is further improved. However, a large amount of addition would not help to improve the tensile strength and elongation at break. Thus, the second aqueous acrylic polymer dispersion, if added, should be added in an appropriate amount.

Advantageously, the polyurethane-acrylic composition according to the present invention is free of a coalescing agent, especially a high boiling coalescing agent or a high boiling film-forming additive. By “free of”, it means that the polyurethane-acrylic composition comprises less than 0.5 wt %, preferably less than 0.1 wt %, preferably 0%, based on the total weight of the polyurethane-acrylic composition, of the coalescing agent. The coalescing agent, especially the high boiling coalescing agent or the high boiling film-forming additive, includes alcohol ester, alcohol ether and the like, and typically has a boiling point of >120° C. This kind of additives in the coating film, with the passage of time, gradually volatilize and escape, resulting in the low temperature flexibility of the coating decreased, the volume of the coating film shrinkage and the adhesion to the substrate decreased. The present acrylic waterproof coating system no longer uses the coalescing agent, which is conductive to environment protection and improves the performance stability of the coating film during the service period.

Advantageously, the aqueous polyurethane dispersion and the aqueous acrylic polymer dispersion and accordingly the polyurethane-acrylic composition according to the present invention are free of organic solvents, in particular free of volatile organic compounds. The aqueous polyurethane dispersion and the aqueous acrylic polymer dispersion and accordingly the polyurethane-acrylic composition according to the present invention are preferably prepared and formulated without volatile organic compounds and only contain water as volatile carrier or liquid phase. Preferably, the aqueous polyurethane dispersion and the aqueous acrylic polymer dispersion and accordingly the polyurethane-acrylic composition according to the present invention comprise less than 5 wt %, preferably less than 1 wt %, preferably 0%, based on the total weight of the aqueous polyurethane dispersion or the aqueous acrylic polymer dispersion or the polyurethane-acrylic composition, of volatile organic compounds (VOC).

### Fillers

The inventive polyurethane-acrylic composition preferably comprises at least one filler. A filler influences the rheological properties of the uncured composition and also the mechanical properties and the surface nature of the fully cured composition. Suitable fillers are inorganic and organic fillers, as for example natural, ground or precipitated chalks (which consist entirely or primarily of calcium carbonate CaCO₃), and which are optionally coated with fatty acids, more particularly stearic acid; barium sulfate (BaSO₄, also called barite or heavy spar), quartz sand, kaolins, especially calcined kaolins, talc, mica, silicas, especially finely divided silicas from pyrolysis processes, PVC powders, or hollow beads. Preferred fillers are calcium carbonate, quartz sand, calcined kaolins, finely divided silicas. It is entirely possible and may even be an advantage to use a mixture of different fillers.

Very preferred as filler for the composition of the invention is chalk (calcium carbonate). Especially preferred is uncoated chalk, most preferably uncoated, ground chalk, as available for example under the brand name Omyacarb® (Omya AG, Switzerland).

Examples of suitable fillers include calcium carbonate, calcium sulfate and calcium containing minerals such as limestone, calcite, chalk, dolomite, wollastonite, apatite, phosphate rock, and mixtures thereof.

The term “filler” refers in the present disclosure to solid particulate materials, which are commonly used as fillers in water-based dispersion compositions and which have low water-solubility. Preferably, the filler has a water-solubility of less than 0.1 g/100 g water, more preferably less than 0.05 g/100 g water, most preferably less than 0.01 g/100 g water, at a temperature of 20° C.

Preferably, the filler has a median particle size d50 in the range of 1.0-100.0 μm, more preferably of 1.0-60.0 μm, most preferably 2.0-50.0 μm.

The term “median particle size d50” refers in the present disclosure to a particle size below which 50% of all particles by volume are smaller than the d50 value. The term “particle size” refers to the area-equivalent spherical diameter of a particle. The particle size distribution can be measured by laser diffraction according to the method as described in standard ISO 13320:2009. A Mastersizer 2000 device (trademark of Malvern Instruments Ltd, GB) can be used in measuring particle size distribution.

Preferably, the one or more fillers are present in the aqueous polyurethane-acrylic composition in a total amount of 10.0-60.0% by weight, preferably 15.0-50.0% by weight, most preferably 20.0-45.0% by weight, based on the total weight of the composition.

In a preferred embodiment of the present invention, the aqueous polyurethane-acrylic composition comprises at least one filler comprising calcium carbonate and optionally an inert filler (preferably a filler inert to acids) preferably selected from a group consisting of barium sulfate, quartz sand, and a combination thereof, preferably in a combined amount of 15-50 wt %, preferably 25-35 wt %, based on the total weight of the composition.

The calcium carbonate has a particle size of 500-1500 mesh, preferably 1000-1250 mesh and preferably has an amount of 28-32 wt % (if no inert filler is added) or 10-22 wt %, or 8-25 wt % (if the inert filler is added), based on the total weight of the composition.

The inert filler (barium sulfate or quartz sand) has a particle size of 500-1500 mesh, preferably 1000-1250 mesh, and preferably has an amount of 8-25 wt %, if added, based on the total weight of the composition.

If the particle size of the filler is too small, the Oil Absorption of the filler will be increased, thereby deteriorating coating of the fillers by the latex and flexibility of the film. In contrast, if the particle size of the filler is too large, the dustproof property, stability, appearance, and water resistance will be deteriorated. Thus, the particle size of the filler should be in an appropriate range.

At present, latex paints on the market have poor acid resistance. In order to reduce costs, many companies only choose CaCO₃ as fillers. The present inventors have found that by combining the inert filler such as BaSO₄ with CaCO₃, the acid resistance and weather resistance of the film can be significantly improved. Preferably, the inert filler BaSO₄ such as has a low Oil Absorption, which would facilitate the wetting and dispersing of the filler and being encapsulated by the emulsion, thereby improving the chalking resistance and flexibility at low temperature of the film. Preferably, the inert filler such as BaSO₄ has an Oil Absorption of <12 g/100 g, preferably 10 g/100 g, as measure according to ISO 787/5.

### Other Components

In a preferred embodiment of the present invention, the present polyurethane-acrylic composition further comprises at least one additional component selected from zinc oxide pre-dispersion, anti-freeze agent, water, pigment, defoamer, wetting and dispersing agent, anti-sagging additives, bactericide, PH regulator, silane coupling agent, and a combination thereof, preferably in a combined amount of 9.6-24 wt % preferably 12-22 wt %, preferably 16-21 wt %, based on the total weight of the composition.

In a preferred embodiment of the present invention, the present polyurethane-acrylic composition comprises a zinc oxide pre-dispersion, preferably in an amount of 0.1-1 wt %, preferably, 0.2-1 wt %, preferably 0.4-0.8 wt %, based on the total weight of the composition. Advantageously, ZnO will form coordination ions with NH3·H2O to initiate carboxyl cross-linking reaction. The carboxy groups on adjacent acrylic molecular chains will jointly form coordination ionic bonds. Therefore, by introducing the zinc oxide (ZnO) pre-dispersion, the compactness of the acrylic coating film is improved, and the tensile strength of the film is increased without affecting the elongation at break. However, if the ZnO is added in a higher dosage (for example, >1 wt %), in the storage process of the composition, the cross-linking reaction intensified, resulting in the coating gel. Thus, considering both performance and storage stability, if added, the ZnO should be added in an appropriate amount.

In a preferred embodiment of the present invention, the present polyurethane-acrylic composition comprises an anti-freeze agent, preferably in an amount of 0.3-1.2 wt %, preferably 0.4-0.8 wt %, based on the total weight of the composition. The suitable anti-freeze agent includes ethylene glycol, propylene glycol and the like. Advantageously, with addition of the anti-freeze agent, the coating has good freeze-thaw resistance, preventing the coating from freezing and demulsification when it is stored and transported below 0° C.

However, since normally the anti-freeze agent is also a high boiling point additive, like the coalescing agent, to some extent, it also affects shrinkage and performance stability of the coating film. When the storage and transportation temperature of the coating is guaranteed, antifreeze additives can be omitted to reduce the shrinkage of the coating film and the emission of VOCs.

In a preferred embodiment of the present invention, the present polyurethane-acrylic composition further comprises at least one additional component selected from water, pigment, defoamer, wetting and dispersing agent, anti-sagging additives, bactericide, PH regulator, silane coupling agent, and a combination thereof, preferably in a combined amount of 9.1-21.8 wt %, preferably 11-21 wt %, preferably 15-20 wt %, based on the total weight of the composition.

Water is preferably added in an amount of 1-12 wt %, preferably 3-9 wt %, based on the total weight of the composition.

The suitable pigment includes TiO₂, and is preferably added in an amount of 3-15 wt %, preferably 5-10 wt %, preferably 6-8 wt %, based on the total weight of the composition.

The suitable defoamer includes compounds based on mineral oils or silicones, and is preferably added in an amount of 0.2-1.2 wt %, preferably 0.4-1 wt %, preferably 0.4-0.9 wt %, preferably 0.6-1 wt %, based on the total weight of the composition.

The suitable wetting and dispersing agent includes inorganic salt dispersants and organic polymer dispersants, and is preferably added in an amount of 0.1-1 wt %, preferably 0.3-0.6 wt %, preferably 0.4-0.5 wt %, based on the total weight of the composition.

The suitable anti-sagging additive includes cellulose ethers, natural polysaccharide derivatives, alkali-swellable thickeners, polyurethane thickeners, montmorillonite and bentonite clays, silica, and is preferably added in an amount of 0.1-1 wt %, preferably 0.05-1 wt %, preferably 0.1-0.4 wt %, based on the total weight of the composition.

The suitable bactericide includes isothiazolinone derivatives such as (2-methyl-4-isothiazolin-3-one (MIT), 5-chloro-2-methyl-4-isothiazolin-3-one (CIT) 1,2-benzisothiazolin-3-one (BIT), 2-n-octyl-4-isothiazolin-3-one (OIT), Carbendazim, and is preferably added in an amount of 0.1-0.4 wt %, preferably 0.1-0.3 wt %, based on the total weight of the composition.

The suitable PH regulator includes AMP 95, NH3·H2O, and is preferably added in an amount of 0.1-0.4 wt %, preferably 0.1-0.3 wt %, based on the total weight of the composition.

The suitable silane coupling agent includes silicone crosslinker, and is preferably added in an amount of 0.1-0.5 wt %, preferably 0.1-0.3 wt %, based on the total weight of the composition.

### Polyurethane-Acrylic Composition and Preparation Method Thereof

Preferably, the present polyurethane-acrylic composition is in the form of a one-component composition.

A composition referred to as a “one-component” composition is one in which all constituents of the composition are in the same container and which is storage-stable per se. Given suitable packaging and storage, it is storage-stable, typically over several months, up to one year or longer.

In a first preferred embodiment of the present invention, the polyurethane-acrylic composition comprises or consists of:
an aqueous acrylic polymer dispersion, preferably in an amount of 17-45 wt %;
an aqueous polyurethane dispersion, preferably in an amount of 4-30 wt %;
calcium carbonate, preferably in an amount of 28-32 wt %;
a zinc oxide pre-dispersion, preferably in an amount of 0.2-1 wt %;
at least one additional component selected from water, pigment, defoamer, wetting and dispersing agent, anti-sagging additives, bactericide, PH regulator, silane coupling agent, and a combination thereof.

Preferably, the polyurethane-acrylic composition comprises or consists of:
an aqueous acrylic polymer dispersion, preferably in an amount of 17-45 wt %;
an aqueous polyurethane dispersion, preferably in an amount of 4-30 wt %;
calcium carbonate, preferably in an amount of 28-32 wt %;
a zinc oxide pre-dispersion, preferably in an amount of 0.2-1 wt %;
water, 3-9 wt %;
a pigment, preferably titanium dioxide, preferably in an amount of 5-10 wt %;
a defoamer, preferably in an amount of 0.4-1 wt %;
a wetting and dispersing agent, preferably in an amount of 0.3-0.6 wt %;
an anti-sagging additive, preferably in an amount of 0.1-0.4 wt %,
a bactericide, preferably in an amount of 0.1-0.3 wt %;
a PH regulator, preferably in an amount of 0.1-0.3 wt %; and
a silane coupling agent, preferably in an amount of 0.1-0.3 wt %.

The first preferred embodiment is characterized by good water resistance, good mechanical strength, minimum heat shrinkage, and environmental friendliness. Specifically, it exhibits a shrinkage rate as low as 0.5% when the dry film is 1.0 mm, good flexibility at −23° C., good tear strength and tensile strength, as well as low water absorption of the coating film.

It is believed that the above performance characteristics can be explained as follows:
a. The anti-freeze additive is also a high boiling point additive. This embodiment does not contain anti-freeze additive, so the coating film has lower heat shrinkage, better adhesion to the substrate, and is more friendly to the environment.
b. This embodiment has higher tensile strength and tear strength, which reflect the best mechanical properties.
c. The content of the polyurethane dispersion in this embodiment can be higher without BaSO₄. The coating has lower water absorption and better water resistance. However, the low temperature flexibility of the coating film can only reach −23° C. It is suitable for flat roofs where water may accumulate, with winter temperatures above −20° C.

In a second preferred embodiment of the present invention, the polyurethane-acrylic composition comprises or consists of:
an aqueous acrylic polymer dispersion, preferably in an amount of 20-45 wt %;
a aqueous polyurethane dispersion, preferably in an amount of 4-30 wt %;
calcium carbonate, preferably in an amount of 10-22 wt %;
barium sulfate, preferably in an amount of 8-25 wt %;
a zinc oxide pre-dispersion, preferably in an amount of 0.2-1 wt %;
at least one additional component selected from water, pigment, defoamer, wetting and dispersing agent, anti-sagging additives, bactericide, PH regulator, silane coupling agent, and a combination thereof.

Preferably, the polyurethane-acrylic composition comprises or consists of:
an aqueous acrylic polymer dispersion, preferably in an amount of 20-45 wt %;
an aqueous polyurethane dispersion, preferably in an amount of 4-30 wt %;
calcium carbonate, preferably in an amount of 10-22 wt %;
barium sulfate, preferably in an amount of 8-25 wt %;
a zinc oxide pre-dispersion, preferably in an amount of 0.2-1 wt %;
water, 3-9 wt %;
a pigment, preferably titanium dioxide, preferably in an amount of 5-10 wt %;
a defoamer, preferably in an amount of 0.4-1 wt %;
a wetting and dispersing agent, preferably in an amount of 0.3-0.6 wt %;
an anti-sagging additive, preferably in an amount of 0.1-0.4 wt %,
a bactericide, preferably in an amount of 0.1-0.3 wt %;
a PH regulator, preferably in an amount of 0.1-0.3 wt %; and
a silane coupling agent, preferably in an amount of 0.1-0.3 wt %.

The second preferred embodiment is characterized by high elongation at break, good elasticity, good weather resistance, environmental friendliness, good acid resistance, lowest heat shrinkage. Specifically, it exhibits a shrinkage rate as low as 0.5% when the dry film is 1.0 mm, good flexibility at −23 to −26° C., excellent acid resistance, as well as excellent elongation at break.

It is believed that the above performance characteristics can be explained as follows:
a. This embodiment can increase the polyurethane dispersion to 30%, which is very benefit to make a coating with high elongation at break and good elasticity. In addition, because it contains BaSO₄, the coating film will have better chemical resistance and weather resistance. It is suitable for roofs with large thermal and cold deformation of the substrate, with large temperature differences between day and night, winter temperatures above −25° C.

In a third preferred embodiment of the present invention, the polyurethane-acrylic composition comprises or consists of:
a first aqueous acrylic polymer dispersion, preferably in an amount of 20-33 wt %;
a second aqueous acrylic polymer dispersion having a Tg lower than that of the first aqueous acrylic polymer dispersion, preferably in an amount of 10-23 wt %;
a aqueous polyurethane dispersion, preferably in an amount of 4-10 wt %;
calcium carbonate, preferably in an amount of 8-25 wt %;
barium sulfate, preferably in an amount of 8-25 wt %;
a zinc oxide pre-dispersion, preferably in an amount of 0.2-1 wt %;
an anti-freeze additive, preferably in an amount of 0.3-1.2 wt %
at least one additional component selected from water, pigment, defoamer, wetting and dispersing agent, anti-sagging additives, bactericide, PH regulator, silane coupling agent, and a combination thereof.

Preferably, the polyurethane-acrylic composition comprises or consists of:
a first aqueous acrylic polymer dispersion, preferably in an amount of 20-33 wt %;
a second aqueous acrylic polymer dispersion having a Tg lower than that of the first aqueous acrylic polymer dispersion, preferably in an amount of 10-23 wt %;
an aqueous polyurethane dispersion, preferably in an amount of 4-10 wt %;
calcium carbonate, preferably in an amount of 8-25 wt %;
barium sulfate, preferably in an amount of 8-25 wt %;
a zinc oxide pre-dispersion, preferably in an amount of 0.2-1 wt %;
an anti-freeze additive, preferably in an amount of 0.3-1.2 wt %
water, 3-9 wt %;
a pigment, preferably titanium dioxide, preferably in an amount of 5-10 wt %;
a defoamer, preferably in an amount of 0.4-1 wt %;
a wetting and dispersing agent, preferably in an amount of 0.3-0.6 wt %;
an anti-sagging additive, preferably in an amount of 0.1-0.4 wt %,
a bactericide, preferably in an amount of 0.1-0.3 wt %;
a PH regulator, preferably in an amount of 0.1-0.3 wt %; and
a silane coupling agent, preferably in an amount of 0.1-0.3 wt %.

The third preferred embodiment is characterized by low temperature flexibility, outstanding acid and weather resistance. Specifically, it exhibits a shrinkage rate<1% when the dry film is 1.0 mm, good flexibility at −30° C., good Q-UV resistance, good freeze-thawing resistance, as well as excellent acid resistance.

It is believed that the above performance characteristics can be explained as follows:
a. This embodiment contains the polyurethane dispersion with a Tg of −30° C. to −40° C. and the acrylic polymer dispersion with a Tg of −30° C. to −40° C. in an amount of 10-20%, thus making the low temperature flexibility of the coating film more outstanding. With more than 8% BaSO₄, the weather resistance will be better. However, when the BaSO₄ content is higher, the water resistance of the coating film will be affected to some extent. The embodiment is more suitable for roofs with a certain slope, in areas with low winter temperature.
b. The anti-freeze additive is beneficial to protect the coating from freezing during low temperature storage and transportation.
c. The heat shrinkage of the coating film is related to the amount of anti-freeze additive. The amount of anti-freeze additives should be <1% in order to ensure that the heat shrinkage is <1% when the coating film thickness is 1 mm.
d. The amount of anti-freeze additive is related to the amount of water. Therefore, the content of water in the composition needs to be less than 9% in order to realize the coating with freeze-thawing resistance.

In winter, the temperature in some countries or areas is as low as −30° C., no long-term water immersion environment, the third embodiment is recommended. If the product is only used in the countries or areas at moderate temperature (for example, in China), no long-term water immersion environment, the first and second embodiments are enough.

The present invention further relates to a preparation method of the polyurethane-acrylic composition, comprising mixing the following components:
at least one aqueous acrylic polymer dispersion, preferably in an amount of 17-56 wt %, preferably 20-45 wt %, based on the total weight of the composition; and
at least one aqueous polyurethane dispersion, preferably in an amount of 4-30 wt %, preferably 4-10 wt %, based on the total weight of the composition;
optionally at least one additional component selected from filler, zinc oxide pre-dispersion, anti-freeze agent, water, pigment, defoamer, wetting and dispersing agent, anti-sagging additives, bactericide, PH regulator, silane coupling agent, and a combination thereof;
wherein the composition is free of a coalescing agent.

Specifically, the preparation method comprises following steps:
a) adding water;
b) adding defoamer, wetting and dispersing agent, bactericide, silane coupling agent, zinc oxide dispersion and anti-sagging additive, and stirring for a period of time to fully disperse the above materials evenly;
b) adding pigment and filler, and stirring for a period of time to fully wet and disperse the powders;
c) adding anti-freeze additive, additional bactericide and -PH regulator, and stirring for a period of time to fully disperse the above materials evenly;
d) adding the acrylic polymer dispersion and the polyurethane dispersion, and stirring for a period of time to fully disperse the above materials evenly;
e) adding additional anti-sagging additive, and stirring for a period of time to fully disperse the above materials evenly;
f) obtaining the composition.

### Applications

The polyurethane-acrylic composition is preferably a coating or an adhesive or a sealant, preferably a coating, preferably a waterproof coating.

The present invention further relates to a method of waterproofing a construction structure, especially a roof, with the polyurethane-acrylic composition as described above, characterized in that, it comprises the following steps:
a) stirring the composition by means of mechanical stirring until achieving complete homogeneity thereof;
b) applying the composition resulting from the previous step a) on the roof by means of a roller, brush, trowel or by spraying.

In a preferred embodiment of the present invention, the method further comprises a following step:
c) applying the composition resulting from the previous step a) on dry layer obtained by step b) by means of a roller, brush, trowel or by spraying.

The present invention further relates to a use of the polyurethane-acrylic composition as described above as waterproofing coating for a construction structure, especially for a roof.

The present invention further relates to a construction structure, especially a roof, coated with the polyurethane-acrylic composition as described above.

### Advantageous Technical Effects

The polyurethane-acrylic composition can bring about at least following advantageous technical effects:
1. By eliminating the high-boiling film-forming additives such as the coalescing agent, low VOC and thus environment protection can be achieved. At the same time, the coating film maintains stable low-temperature flexibility and good bonding strength during service.
2. By incorporating the polyurethane dispersion with excellent properties with the acrylic polymer dispersion, high strength, high elongation at break, and low temperature flexibility at −30° C. of the coating film at the same time have been obtained.
3. By further introducing BaSO₄, compounding it with CaCO₃, acid resistance, elongation at break and weather resistance of the coating film have been further improved.
4. By further introducing zinc oxide pre-dispersion, the cross-linking density of acrylic acid and thus the compactness of the coating film have been further improved.

Combining the above points, an environmentally friendly roof waterproof coating has been achieved with high tensile strength, good elasticity, large elongation at break, good low temperature flexibility, low heat shrinkage, low VOC, excellent weather resistance, long waterproof life, wide practical range, easy construction and maintenance. It has solved the shortcomings of existing waterproof coating in performance and environmental protection.

### EXAMPLES

Working examples are adduced hereinafter, which are intended to further elucidate the invention described. Of course, the invention is not limited to these described working examples.

### Preparation of the Compositions

Prepare a clean the production equipment, put water into it, turn on the mixer, and control the speed to 300-500 rpm/min. Continue to add defoamer/dispersant/bactericide/silane coupling agent SILQUEST A-187/zinc oxide dispersion (HKJ102-1)/rheology aid, stir for 5 minutes to fully disperse the above materials evenly. Continue to add TiO₂/CaCO₃/BaSO₄, increase the speed of the disperser to 700-1000 rpm/min, and disperse for 40-60 min to fully wet and disperse the powder. Continue to add antifreeze auxiliary (Propylene glycol techn)/PH adjuster (AMP95) and stir for 5-10 min. Reduce the speed of the disperser to 400-500 rpm/min, continue to add the emulsion (Bayhydrol UH 2864/PRIMAL EC4811/PRIMAL EC1791) and stir for 5-10 min. Finally, add rheological additive and stir for 5-10 min.

The formulations of the compositions and test results thereof are shown below in Table 1.

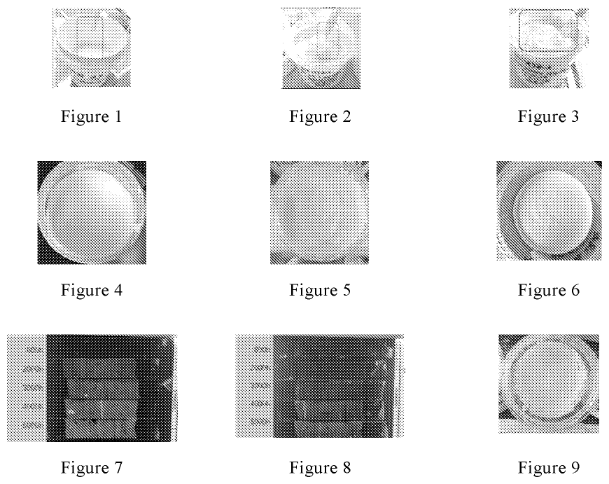

TABLE 1
Formulations of compositions and test results thereof.

| Type | Component (commercial name & supplier) | Ex. 1 | Ex. 2 | Ex. 3 |
|---|---|---|---|---|
| Emulation | PRIMAL EC4811 (Dow) | 47.6 | 47.6 | 47.6 |
| Emulation | Bayhydrol UH 2864 (Covestro) | 0 | 0 | 0 |
| Emulation | PRIMAL EC1791 (Dow) | 0 | 0 | 0 |
| Emulation | Acronal ® 7562 X (BASF) | | | |
| Filler | CaCO3 (1000-1250mesh) | 30.91 | 30.91 | 30.91 |
| Filler | BaSO4 (1000-1250mesh) | 0 | 0 | 0 |
| Anti-freeze | Propylene glycol techn. (pail) (Dow) | 2 | 2 | 2 |
| coalescing agent | Texanol 2,2,4-Trimethyl-1,3-pentandiol- | 1.5 | 1.5 | 1.5 |
| | monoisobutyrat | | | |
| | (EASTMAN CHEMICAL COMPANY) | | | |
| Functional additives | ZnO pre-dispersion (HKJ102-1) (HUIZHOU | 0 | 0.5 | 1 |
| | HUANMEISHENG NEW MATERIAL) | | | |
| white pigment | TiO2 | 7.54 | 7.54 | 7.54 |
| acticide | acticide | 0.25 | 0.25 | 0.25 |
| wetting/dispersing agent | acrylic acid ammonium salt | 0.4 | 0.4 | 0.4 |
| defoamer | metallic soap | 0.9 | 0.9 | 0.9 |
| silane coupling agent | SILQUEST A-187 (Momentive) | 0.2 | 0.2 | 0.2 |
| anti-sagging additives | non-ionic hydroxyethylcellulose | 0.34 | 0.34 | 0.34 |
| PH regulator | (AMP 95) (Dow) | 0.2 | 0.2 | 0.2 |
| Water cold (bulk) | | 8.16 | 8.16 | 8.16 |
| | Total | 100 | 100.5 | 101 |
| Test method | Performance | | | |
| JC/T 864-2008&JG/T375-2012 | Tensile strength [MPa] | 1.51 | 1.93 | 2.27 |
| | Elongation at break [%] | 644 | 544 | 482 |
| | Shrinkage rate[%] | 1.51 | 1.55 | 1.51 |
| | Flexibility at low temperature | −25 deg C./ | −25 deg C./ | −25 deg C./ |
| | | ok | ok | ok |
| | Tear strength [N/mm] | 13.2 | 13.8 | 14.7 |
| | Water absolution[%] | 13.3 | 13.5 | 10.9 |
| | Tensile strength after acid resistance [MPa] | | | |
| | Elongation at break after acid resistance[%] | | | |
| Sika Internal test method | Storage stability on shaking table for 10 days | FIG. 1 | FIG. 2 | FIG. 3 |
| GB/T 9268-2008 | Freeze thaw resistance | | | |
| | test(−5 deg C./18 h, 23 deg C./5 h) | | | |
| GB/T23987-2009 | Q-UV A test | | | |

| Type | Component (commercial name) | Ex. 4 | Ex. 5 | Ex. 6 | Ex. 7 |
|---|---|---|---|---|---|
| Emulation | PRIMAL EC4811 (Dow) | 42.87 | 38.14 | 28.68 | 17.6 |
| Emulation | Bayhydrol UH 2864 (Covestro) | 4.73 | 9.46 | 18.92 | 30 |
| Emulation | PRIMAL EC1791 (Dow) | 0 | 0 | 0 | 0 |
| Emulation | Acronal ® 7562 X (BASF) | | | | |
| Filler | CaCO3 (1000-1250mesh) | 30.91 | 30.91 | 30.91 | 30.91 |
| Filler | BaSO4 (1000-1250mesh) | 0 | 0 | 0 | 0 |
| Anti-freeze | Propylene glycol techn. (pail) (Dow) | 2 | 2 | 2 | 2 |
| coalescing agent | Texanol 2,2,4-Trimethyl-1,3-pentandiol- | 1.5 | 1.5 | 1.5 | 1.5 |
| | monoisobutyrat | | | | |
| | (EASTMAN CHEMICAL COMPANY) | | | | |
| Functional additives | ZnO pre-dispersion (HKJ102-1) (HUIZHOU | 0 | 0 | 0 | 0 |
| | HUANMEISHENG NEW MATERIAL) | | | | |
| white pigment/TiO₂ | TiO2 | 7.54 | 7.54 | 7.54 | 7.54 |
| acticide | acticide | 0.25 | 0.25 | 0.25 | 0.25 |
| wetting/dispersing agent | acrylic acid ammonium salt | 0.4 | 0.4 | 0.4 | 0.4 |
| defoamer | metallic soap | 0.9 | 0.9 | 0.9 | 0.9 |
| silane coupling agent | SILQUEST A-187 (Momentive) | 0.2 | 0.2 | 0.2 | 0.2 |
| anti-sagging additives | non-ionic hydroxyethylcellulose | 0.34 | 0.34 | 0.34 | 0.34 |
| PH regulator | (AMP 95) (Dow) | 0.2 | 0.2 | 0.2 | 0.2 |
| Water cold (bulk) | | 8.16 | 8.16 | 8.16 | 8.16 |
| | Total | 100 | 100 | 100 | 100 |
| Test method | Performance | | | | |
| JC/T 864-2008&JG/T375-2012 | Tensile strength [MPa] | 1.9 | 1.9 | 1.91 | 1.94 |
| | Elongation at break [%] | 495 | 429 | 470 | 483 |
| | Shrinkage rate[%] | 1.46 | 1.5 | 1.46 | 1.51 |
| | Flexibility at low temperature | −27 deg C./ | −27 deg C./ | −30 deg C./ | −30 deg C./ |
| | | ok | ok | ok | ok, ′−31 deg C./ |
| | | | | | Failure |
| | Tear strength [N/mm] | 14 | 14.3 | 14.3 | 14.6 |
| | Water absolution[%] | 13.7 | 11 | 9.8 | n.a |
| | Tensile strength after acid resistance [MPa] | 1.75 | 1.78 | 1.78 | n.a |
| | Elongation at break after acid resistance[%] | 250 | 203 | 263 | n.a |
| Sika Internal test method | Storage stability on shaking table for 10 days | | | | |
| GB/T 9268-2008 | Freeze thaw resistance | | | | |
| | test(−5 deg C./18 h, 23 deg C./5 h) | | | | |
| GB/T23987-2009 | Q-UV A test | | | | |

| Type | Component (commercial name) | Ex8 | Ex9 | Ex10 |
|---|---|---|---|---|
| Emulation | PRIMAL EC4811 (Dow) | 42.87 | 42.87 | 42.87 |
| Emulation | Bayhydrol UH 2864 (Covestro) | 4.73 | 4.73 | 4.73 |
| Emulation | PRIMAL EC1791 (Dow) | 0 | 0 | 0 |
| Emulation | Acronal ® 7562 X (BASF) | | | |
| Filler | CaCO3 (1000-1250mesh) | 30.91 | 30.91 | 30.91 |
| Filler | BaSO4 (1000-1250mesh) | 0 | 0 | 0 |
| Anti-freeze | Propylene glycol techn. (pail) (Dow) | 2 | 0.5 | 0 |
| coalescing agent | Texanol 2,2,4-Trimethyl-1,3-pentandiol- | 0 | 0 | 0 |
| | monoisobutyrat | | | |
| | (EASTMAN CHEMICAL COMPANY) | | | |
| Functional additives | ZnO pre-dispersion (HKJ102-1) (HUIZHOU | 0 | 0 | 0 |
| | HUANMEISHENG NEW MATERIAL) | | | |
| white pigment/TiO₂ | TiO2 | 7.54 | 7.54 | 7.54 |
| acticide | acticide | 0.25 | 0.25 | 0.25 |
| wetting/dispersing agent | acrylic acid ammonium salt | 0.4 | 0.4 | 0.4 |
| defoamer | metallic soap | 0.9 | 0.9 | 0.9 |
| silane coupling agent | SILQUEST A-187 (Momentive) | 0.2 | 0.2 | 0.2 |
| anti-sagging additives | non-ionic hydroxyethylcellulose | 0.34 | 0.34 | 0.34 |
| PH regulator | (AMP 95) (Dow) | 0.2 | 0.2 | 0.2 |
| Water cold (bulk) | | 8.16 | 8.16 | 8.16 |
| | Total | 98.5 | 97 | 96.5 |
| Test method | Performance | | | |
| JC/T 864-2008&JG/T375-2012 | Tensile strength [MPa] | 2.2 | 2.2 | 2.18 |
| | Elongation at break [%] | 373 | 357 | 363 |
| | Shrinkage rate[%] | 1.05 | 0.67 | 0.5 |
| | Flexibility at low temperature | −23 deg C./ | −23 deg C./ | −23 deg C./ |
| | | Failure | Failure | Failure |
| | Tear strength [N/mm] | 15.7 | 15.6 | 17.1 |
| | Water absolution[%] | 13.5 | 13.1 | 13.5 |
| | Tensile strength after acid resistance [MPa] | n.a | n.a | 1.83 |
| | Elongation at break after acid resistance[%] | n.a | n.a | 180 |
| Sika Internal test method | Storage stability on shaking table for 10 days | | | |
| GB/T 9268-2008 | Freeze thaw resistance | FIG. 4 | FIG. 5 | FIG. 6 |
| | test(−5 deg C./18 h, 23 deg C./5 h) | Excellent | Freeze-thaw | Freeze and |
| | | freeze-thaw | resistance is | demulsify |
| | | resistance | acceptable | after thawing |
| GB/T23987-2009 | Q-UV A test | | | FIG. 7 |
| Type | Component (commercial name) | Ex11 | Ex12 | Ex13 |
| Emulation | PRIMAL EC4811 (Dow) | 42.87 | 42.87 | 42.87 |
| Emulation | Bayhydrol UH 2864 (Covestro) | 4.73 | 4.73 | 4.73 |
| Emulation | PRIMAL EC1791 (Dow) | 0 | 0 | 0 |
| Emulation | Acronal ® 7562 X (BASF) | | | |
| Filler | CaCO3 (1000-1250mesh) | 25.91 | 20.91 | 0 |
| Filler | BaSO4 (1000-1250mesh) | 5 | 10 | 30.91 |
| Anti-freeze | Propylene glycol techn. (pail) (Dow) | 0 | 0 | 0 |
| coalescing agent | Texanol 2,2,4-Trimethyl-1,3-pentandiol- | 0 | 0 | 0 |
| | monoisobutyrat | | | |
| | (EASTMAN CHEMICAL COMPANY) | | | |
| Functional additives | ZnO pre-dispersion (HKJ102-1) (HUIZHOU | 0 | 0 | 0 |
| | HUANMEISHENG NEW MATERIAL) | | | |
| white pigment/TiO₂ | TiO2 | 7.54 | 7.54 | 7.54 |
| acticide | acticide | 0.25 | 0.25 | 0.25 |
| wetting/dispersing agent | acrylic acid ammonium salt | 0.4 | 0.4 | 0.4 |
| defoamer | metallic soap | 0.9 | 0.9 | 0.9 |
| silane coupling agent | SILQUEST A-187 (Momentive) | 0.2 | 0.2 | 0.2 |
| anti-sagging additives | non-ionic hydroxyethylcellulose | 0.34 | 0.34 | 0.34 |
| PH regulator | (AMP 95) (Dow) | 0.2 | 0.2 | 0.2 |
| Water cold (bulk) | | 8.16 | 8.16 | 8.16 |
| | Total | 96.5 | 96.5 | 96.5 |
| Test method | Performance | | | |
| JC/T 864-2008&JG/T375-2012 | Tensile strength [MPa] | 2.14 | 2.08 | 1.98 |
| | Elongation at break [%] | 373 | 460 | 550 |
| | Shrinkage rate[%] | 0.67 | 0.67 | 0.67 |
| | Flexibility at low temperature | −23 deg C./ | −23 deg C./ | −25 deg C./ |
| | | ok | ok | ok |
| | Tear strength [N/mm] | 16.1 | 16.7 | 16.3 |
| | Water absolution[%] | 13.8 | 18.6 | 22.8 |
| | Tensile strength after acid resistance [MPa] | 2.1 | 2.2 | 2.1 |
| | Elongation at break after acid resistance[%] | 244 | 320 | 447 |
| Sika Internal test method | Storage stability on shaking table for 10 days | | | |
| GB/T 9268-2008 | Freeze thaw resistance | | | |
| | test(−5 deg C./18 h, 23 deg C./5 h) | | | |
| GB/T23987-2009 | Q-UV A test | | | FIG. 8 |

| Type | Component (commercial name) | Ex14 | Ex15 | Ex16 | Ex17 |
|---|---|---|---|---|---|
| Emulation | PRIMAL EC4811 (Dow) | 37.87 | 22.87 | 0 | 22.87 |
| Emulation | Bayhydrol UH 2864 (Covestro) | 4.73 | 4.73 | 4.73 | 4.73 |
| Emulation | PRIMAL EC1791 (Dow) | 5 | 20 | | 20 |
| Emulation | Acronal ® 7562 X (BASF) | | | 42.87 | |
| Filler | CaCO3 (1000-1250mesh) | | | | 10 |
| Filler | BaSO4 (1000-1250mesh) | 30.91 | 30.91 | 30.91 | 20.91 |
| Anti-freeze | Propylene glycol techn. (pail) (Dow) | 0 | 0 | 0 | 0 |
| coalescing agent | Texanol 2,2,4-Trimethyl-1,3-pentandiol- | 0 | 0 | 0 | 0 |
| | monoisobutyrat | | | | |
| | (EASTMAN CHEMICAL COMPANY) | | | | |
| Functional additives | ZnO pre-dispersion (HKJ102-1) (HUIZHOU | 0 | 0 | 0 | 0 |
| | HUANMEISHENG NEW MATERIAL) | | | | |
| white pigment/TiO₂ | TiO2 | 7.54 | 7.54 | 7.54 | 7.54 |
| acticide | acticide | 0.25 | 0.25 | 0.25 | 0.25 |
| wetting/dispersing agent | acrylic acid ammonium salt | 0.4 | 0.4 | 0.4 | 0.4 |
| defoamer | metallic soap | 0.9 | 0.9 | 0.9 | 0.9 |
| silane coupling agent | SILQUEST A-187 (Momentive) | 0.2 | 0.2 | 0.2 | 0.2 |
| anti-sagging additives | non-ionic hydroxyethylcellulose | 0.34 | 0.34 | 0.34 | 0.34 |
| PH regulator | (AMP 95) (Dow) | 0.2 | 0.2 | 0.2 | 0.2 |
| Water cold (bulk) | | 8.16 | 8.16 | 8.16 | 8.16 |
| | Total | 96.5 | 96.5 | 96.5 | 96.5 |
| Test method | Performance | | | | |
| JC/T 864-2008&JG/T375-2012 | Tensile strength [MPa] | 2 | 1.97 | 1.54 | 1.89 |
| | Elongation at break [%] | 475 | 330 | 222 | 314 |
| | Shrinkage rate[%] | 0.73 | 0.66 | n.a | 0.67 |
| | Flexibility at low temperature | −28 deg C./ | −30 deg C./ | −32 deg C./ | −28 deg C./ |
| | | Failure | ok | ok | ok |
| | Tear strength [N/mm] | 15.5 | 13.9 | 10.2 | 14.5 |
| | Water absolution[%] | 20.4 | 21.8 | 19.7 | 14.8 |
| | Tensile strength after acid resistance [MPa] | 1.6 | 1.53 | 1.24 | 1.83 |
| | Elongation at break after acid resistance[%] | 344 | 299 | 217 | 259 |
| Sika Internal test method | Storage stability on shaking table for 10 days | | | | |
| GB/T 9268-2008 | Freeze thaw resistance | | | | |
| | test(−5 deg C. /18 h, 23 deg C./5 h) | | | | |
| GB/T23987-2009 | Q-UV A test | | | | |
| Type | Component (commercial name) | Ex18 | Ex19 | Ex20 | Ex21 |
| Emulation | PRIMAL EC4811 (Dow) | 42.87 | 42.87 | 22.87 | 22.87 |
| Emulation | Bayhydrol UH 2864 (Covestro) | 4.73 | 4.73 | 4.73 | 4.73 |
| Emulation | PRIMAL EC1791 (Dow) | 0 | 0 | 20 | 20 |
| Emulation | Acronal ® 7562 X (BASF) | | | | |
| Filler | CaCO3 (1000-1250mesh) | 30.91 | 20.91 | 10 | 10 |
| Filler | BaSO4 (1000-1250mesh) | 0 | 10 | 20.91 | 20.91 |
| Anti-freeze | Propylene glycol techn. (pail) (Dow) | 0 | 0 | 0 | 0.5 |
| coalescing agent | Texanol 2,2,4-Trimethyl-1,3-pentandiol- | 0 | 0 | 0 | 0 |
| | monoisobutyrat | | | | |
| | (EASTMAN CHEMICAL COMPANY) | | | | |
| Functional additives | ZnO pre-dispersion (HKJ102-1) (HUIZHOU | 0.5 | 0.5 | 0.5 | 0.5 |
| | HUANMEISHENG NEW MATERIAL) | | | | |
| white pigment/TiO₂ | TiO2 | 7.54 | 7.54 | 7.54 | 7.54 |
| acticide | acticide | 0.25 | 0.25 | 0.25 | 0.25 |
| wetting/dispersing agent | acrylic acid ammonium salt | 0.4 | 0.4 | 0.4 | 0.4 |
| defoamer | metallic soap | 0.9 | 0.9 | 0.9 | 0.9 |
| silane coupling agent | SILQUEST A-187 (Momentive) | 0.2 | 0.2 | 0.2 | 0.2 |
| anti-sagging additives | non-ionic hydroxyethylcellulose | 0.34 | 0.34 | 0.34 | 0.34 |
| PH regulator | (AMP 95) (Dow) | 0.2 | 0.2 | 0.2 | 0.2 |
| Water cold (bulk) | | 8.16 | 8.16 | 8.16 | 8.16 |
| | Total | 97 | 97 | 97 | 97.5 |
| Test method | Performance | | | | |
| JC/T 864-2008&JG/T375-2012 | Tensile strength [MPa] | 2.4 | 2.24 | 2.13 | 2.06 |
| | Elongation at break [%] | 333 | 470 | 310 | 350 |
| | Shrinkage rate [%] | 0.65 | 0.67 | 0.65 | 0.77 |
| | Flexibility at low temperature | −23 deg C./ | −23 deg C./ | −28 deg C./ | −30 deg C./ |
| | | Failure | ok | ok | ok |
| | Tear strength [N/mm] | 18 | 17.2 | 15.3 | 14.5 |
| | Water absolution[%] | 13.1 | 17.8 | 14.3 | 14.8 |
| | Tensile strength after acid resistance [MPa] | 2.1 | 2.25 | 1.94 | 1.86 |
| | Elongation at break after acid resistance[%] | 190 | 350 | 270 | 295 |
| Sika Internal test method | Storage stability on shaking table for 10 days | | | | |
| GB/T 9268-2008 | Freeze thaw resistance | | | | FIG. 9 |
| | test(−5 deg C./18 h, 23 deg C./5 h) | | | | Freeze-thaw |
| | | | | | resistance is |
| | | | | | acceptable |
| GB/T23987-2009 | Q-UV A test | | | | |

As seen from EX. 1/2/3, the addition of ZnO dispersions can greatly increase the tensile strength. However, when the dosage reaches 1%, in the storage process, the cross-linking reaction intensified, resulting in the coating gel.

As seen from EX. 1/4/5/6, the introduction of PUD is conducive to the film tensile strength, flexibility at low-temperature and reduces the water absorption of the coating. To some extent PUD weakens the elongation at break of the coating. As seen from EX.7, when the proportion of PUD reaches 30%, the product performance has not been significantly improved, but it has brought huge cost pressure.

As seen from EX.4/8/9/10, the freeze-thaw resistance of the coating is significantly improved with addition of the anti-freeze agent. However, high boiling point additives (the coalescing agent and the anti-freeze agent) have a direct effect on shrinkage of the film after heat treatment. When the two additives are withdrawn, the shrinkage decreases significantly. In addition, to some extent, they also bring negative effects on the low-temperature flexibility and the elongation at break before and after acid treatment.

As seen from EX.10/11/12/13, with the increase of the proportion of BaSO₄, flexibility at low temperature and the elongation at break before and after acid treatment are significantly improved, but a large amount of addition will increase the water absorption of the film, which is not conducive to the waterproof of the film. As seen from EX.10/13, BaSO₄ completely replacing CaCO₃ can significantly improve the chalking resistance of the film.

As seen from EX.13/14/15, with the increase of the proportion of primary EC1791, the flexibility of the film is further improved. However, a large amount of addition does not help to improve the water absorption of the film, and also affects the elongation at break before and after acid treatment.

As seen from EX.16, the acrylic emulsion AN7562 (BASF) with a low Tg (−35° C.) is benefit to flexibility of the film at very low temperature, but also affects the mechanical properties before and after acid treatment.

Considering all the above properties, the formulas as shown in EX.10/12/17/18/19/20/21 are more appropriate. Among them, EX10/18 exhibit improved tensile strength and tear strength, environmentally friendliness, and good water resistance. EX/12/19 exhibit high strength and elongation at break, and also have better low temperature flexibility, environmentally friendliness. EX17/20/21 exhibit low temperature performance up to −30° C., freeze-thaw resistance of the coating, and outstanding weather resistance.

In the context of the present application, the term “comprising” is considered synonymous with the term “including”. Likewise whenever a composition, an element or a group of elements is preceded with the transitional phrase “comprising”, it is understood that we also contemplate the same composition or group of elements with transitional phrases “consisting essentially of”, “consisting of”, “selected from the group of consisting of”, or “is” preceding the recitation of the composition, element, or elements and vice versa, e.g., the terms “comprising”, “consisting essentially of”, “consisting of” also include the product of the combinations of elements listed after the term.

1. A polyurethane-acrylic composition, wherein, it comprises:
at least one aqueous acrylic polymer dispersion, based on the total weight of the composition; and
at least one aqueous polyurethane dispersion, based on the total weight of the composition;
wherein the composition is free of a coalescing agent.

2. The polyurethane-acrylic composition according to claim 1, wherein,
the aqueous polyurethane dispersion has a Tg of ≤−30° C.

3. The polyurethane-acrylic composition according to claim 1, wherein,
the at least one aqueous acrylic polymer dispersion is selected from a pure acrylic emulsion, a styrene-acrylic emulsion, and a combination thereof.

4. The polyurethane-acrylic composition according to claim 1, wherein
the aqueous acrylic polymer dispersion has a Tg of ≤−10° C.

5. The polyurethane-acrylic composition according to claim 1, wherein,
the at least one aqueous acrylic polymer dispersion comprises a first aqueous acrylic polymer dispersion and a second aqueous acrylic polymer dispersion having a Tg lower than that of the first aqueous acrylic polymer dispersion.

6. The polyurethane-acrylic composition according to claim 5, wherein,
the first aqueous acrylic polymer dispersion has an amount of 20-33 wt %, and the second aqueous acrylic polymer dispersion has an amount of 10-23 wt %, based on the total weight of the composition.

7. The polyurethane-acrylic composition according to claim 1, wherein,
the composition further comprises at least one filler comprising calcium carbonate and optionally an inert filler.

8. The polyurethane-acrylic composition according to claim 1, wherein,
the composition further comprises a zinc oxide pre-dispersion, based on the total weight of the composition.

9. The polyurethane-acrylic composition according to claim 1, wherein,
the composition further comprises an anti-freeze agent, based on the total weight of the composition.

10. The polyurethane-acrylic composition according to claim 1, wherein,
the composition further comprises at least one additional component selected from water, pigment, defoamer, wetting and dispersing agent, anti-sagging additives, bactericide, PH regulator, silane coupling agent, and a combination thereof.

11. The polyurethane-acrylic composition according to claim 1, wherein, it comprises:
an aqueous acrylic polymer dispersion;
an aqueous polyurethane dispersion;
calcium carbonate;
a zinc oxide pre-dispersion;
at least one additional component selected from water, pigment, defoamer, wetting and dispersing agent, anti-sagging additives, bactericide, PH regulator, silane coupling agent, and a combination thereof.

12. The polyurethane-acrylic composition according to claim 1, wherein, it comprises:
an aqueous acrylic polymer dispersion;
a aqueous polyurethane dispersion;
calcium carbonate;
barium sulfate;
a zinc oxide pre-dispersion;
at least one additional component selected from water, pigment, defoamer, wetting and dispersing agent, anti-sagging additives, bactericide, PH regulator, silane coupling agent, and a combination thereof.

13. The polyurethane-acrylic composition according to claim 1, wherein, it comprises
a first aqueous acrylic polymer dispersion;
a second aqueous acrylic polymer dispersion having a Tg lower than that of the first aqueous acrylic polymer dispersion;
a aqueous polyurethane dispersion;
calcium carbonate;
barium sulfate;
a zinc oxide pre-dispersion;
an anti-freeze additive;
at least one additional component selected from water, pigment, defoamer, wetting and dispersing agent, anti-sagging additives, bactericide, PH regulator, silane coupling agent, and a combination thereof.

14. A method of waterproofing a construction structure, with the polyurethane-acrylic composition according to claim 1, wherein, it comprises the following steps:
a) stirring the composition by means of mechanical stirring until achieving complete homogeneity thereof;
b) applying the composition resulting from the previous step a) on the roof by means of a roller, brush, trowel or by spraying.

15. The method according to claim 14, wherein, it further comprises a following step:
c) applying the composition resulting from the previous step a) on dry layer obtained by step b) by means of a roller, brush, trowel or by spraying.

16. A method of waterproofing coating for a construction structure with the polyurethane-acrylic composition according to claim 1.

17. A construction structure, coated with the polyurethane-acrylic composition according to claim 1.
